(19) United States
(12) Patent Application Publication
(10) Pub. No.: US 2026/0138019 A1
(43) Pub. Date: May 21, 2026

(54) INTERACTIVE CHAIN-OF-THOUGHT EXPLANATION(S) FOR VIDEO GAME(S)

(71) Applicant: GOOGLE LLC, Mountain View, CA (US)

(72) Inventor: Agoston Weisz, Zurich (CH)

(21) Appl. No.: 18/950,699

(22) Filed: Nov. 18, 2024

(51) Int. Cl. A63F 13/5375; A63F 13/67; A63F 13/79; G06F 40/40

(52) U.S. Cl. CPC A63F 13/5375; A63F 13/67; A63F 13/79; G06F 40/40

(57) ABSTRACT

Implementations described herein relate to methods and systems for improving gameplay of video games by providing users with interactive, natural language explanations of optimal strategies, and by processing actual images and/or videos of gameplay to provide context for these explanations. Processor(s) of a system can: receive multimedia content that captures gameplay of a video game; process, using a generative model (GM), at least an indication of the multimedia content that captures the gameplay of the video game; and determine a chain-of-thought to improve the gameplay of the video game. In some implementations, portion(s) of the CoT can be rendered in response to receiving natural language prompt(s), whereas in other implementations the portion(s) of the CoT can be rendered proactively (e.g., based on monitoring the gameplay of the user's video game).

### BACKGROUND

Various machine learning models have been proposed that can analyze gameplay of a video game and provide suggestions to users in real-time or, upon completion of a video game, provide post-game analysis to optimize performance of gameplay of the user. For example, some machine learning models have been proposed that are trained based on prior feature(s) of prior gameplay. Accordingly, these machine learning models can process current feature(s) of current gameplay to provide suggestions to improve the current gameplay, or provide a review of the current gameplay after the current gameplay is concluded.

Some non-generative machine learning models can analyze gameplay of a video game and provide suggestions to users in real-time or, upon completion of a video game, provide post-game analysis to optimize performance of gameplay of the user. For example, these machine learning models have been proposed that are trained based on prior feature(s) of prior gameplay. Accordingly, these machine learning models can process current feature(s) of current gameplay to provide suggestions to improve the current gameplay, or provide a review of the current gameplay after the current gameplay is concluded. However, these suggestions typically provide an action to perform in the current gameplay without providing an explanation as to why the user should take the action and/or how it will improve the current gameplay. Further, these generative models are typically not interactive in that the user cannot engage in natural language conversations therewith to request additional information or context related to these suggestions. Moreover, many of these machine learning models are not capable of processing actual images/videos, of the current gameplay, that can provide additional context that is included in the current feature(s).

### SUMMARY

Implementations described herein relate to methods and systems for improving gameplay of video games by providing users with interactive, natural language explanations of optimal strategies, and by processing actual images and/or videos of gameplay to provide context for these explanations. Processor(s) of a system can: receive multimedia content that captures gameplay of a video game; process, using a generative model (GM), at least an indication of the multimedia content that captures the gameplay of the video game; and determine a chain-of-thought (CoT) to improve the gameplay of the video game. In some implementations, portion(s) of the CoT can be rendered in response to receiving natural language prompt(s). In these implementations, the natural language prompt(s) can be provided by a user that may or may not be playing the video game, and an indication of the natural language prompt(s) can be processed along with the indication of the multimedia content that captures the gameplay of the video game to determine the CoT. In additional or alternative implementations, the portion(s) of the CoT can be rendered proactively (e.g., based on monitoring the gameplay of the user's video game). In these implementations, the system can continuously monitor the multimedia content that captures the gameplay of the video game and determine whether to render the portion(s) of the CoT based on, for example, a current state of the gameplay and/or whether the gameplay is deviating from the CoT or is predicted to deviate from the CoT.

For example, a user playing online chess could ask “What is the best move?”. In this example, the system can process, using the GM, an indication of the natural language prompt (the question “What is the best move?”) along with an indication of the multimedia content that captures a current position on the chess board. Further, and based on processing the indication of the natural language prompt and the indication of the multimedia content, the system can determine a CoT to improve the gameplay of the online chess game. For instance, the CoT may describe the opponent's likely attack plans, the user's weaknesses, and the need for additional defense without explicitly recommending a specific move like “Nf3.” The user can continue interacting with the system to request additional information, which allows the user to understand the reasoning behind the model's suggestions and make informed decisions.

In some implementations, and prior to determining any CoT(s), the system can train and/or fine-tune the GM using supervised fine-tuning (SFT) techniques and/or reinforcement learning from human feedback (RLHF) techniques. For example, the system can SFT the GM by processing various SFT training instances that each include a current state (e.g., a current position on the chess board) of a video game and a corresponding sequence of optimal actions to take in the current state of the video game and to arrive at an optimal state in the video game. Additional detail on training and/or fine-tuning the GM using SFT techniques is described herein. Also, for example, the system can utilize RLHF for the GM by processing various RLHF training instances to generate a corresponding predicted CoT, and a human reviewer can review the corresponding CoT and provide feedback (e.g., via a developer device) that is utilized by the system to reinforce and/or update the GM. Additional detail on training and/or fine-tuning the GM using RLHF techniques is described herein.

By using techniques described herein, one or more technical advantages can be achieved with respect to various technical problems. For example, one or more technical problems can relate to providing users with interactive, natural language explanations of optimal strategies to improve gameplay of a video game by guiding users through the way the user's gameplay affects the video game in terms of the optimal state (e.g., best possible gameplay) of the video game. Thus, the proposed systems and methods can improve upon existing solutions by guiding users through the way the user's gameplay affects the video game in terms of the optimal state of the video game, in addition to providing co-occurring, natural language explanations of why such gameplay is or will be affected so that users can understand the effects of their gameplay and know why, accordingly.

Additionally or alternatively, one or more technical problems can relate to providing users with interactive, natural language explanations of optimal strategies to improve gameplay of a video game by processing actual images/videos of gameplay in order to provide context for these explanations. Thus, the proposed systems and methods can improve upon existing solutions by processing actual images/videos of gameplay in order to provide context for the natural language explanations of why such gameplay is or will be affected, accordingly. Moreover, users can continue to interact with the proposed systems described herein via natural language requests/queries that are received by the proposed systems, and as a result of these interactions, these proposed systems can further guide users through the way the user's gameplay affects the video game in terms of the optimal state of the video game, in addition to providing co-occurring, natural language explanations of why such gameplay is or will be affected so that users can understand the effects of their gameplay and know why, accordingly.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts a flowchart illustrating an example method of supervised fine-tuning (SFT) of a generative model (GM) to enable generation of chain-of-thought(s) (CoT(s)) for a video game, in accordance with various implementations.

FIG. 3 depicts a flowchart illustrating an example method of performing reinforcement learning from human feedback (RLHF) for a generative model (GM) to enable generation of chain-of-thought(s) (CoT(s)) for a video game, in accordance with various implementations.

FIG. 4 depicts a flowchart illustrating an example method of using a generative model (GM) to generate chain-of-thought(s) (CoT(s)) for a video game and in response to receiving natural language prompt(s) from a client device of a user, in accordance with various implementations.

FIG. 5 depicts a flowchart illustrating an example method of using a generative model (GM) to generate chain-of-thought(s) (CoT(s)) for a video game and determining whether to proactively render the CoT(s) at a client device of a user, in accordance with various implementations.

FIG. 6A and FIG. 6B depict various non-limiting examples of utilizing a generative model (GM) to generate chain-of-thought(s) (CoT(s)) for a video game and in response to receiving natural language prompt(s) from a client device of a user, in accordance with various implementations.

FIG. 7A and FIG. 7B depict various non-limiting examples of utilizing a generative model (GM) to generate chain-of-thought(s) (CoT(s)) for a video game and determining whether to proactively render the CoT(s) at a client device of a user, in accordance with various implementations.

FIG. 8 depicts an example architecture of a computing device, in accordance with various implementations.

### DETAILED DESCRIPTION

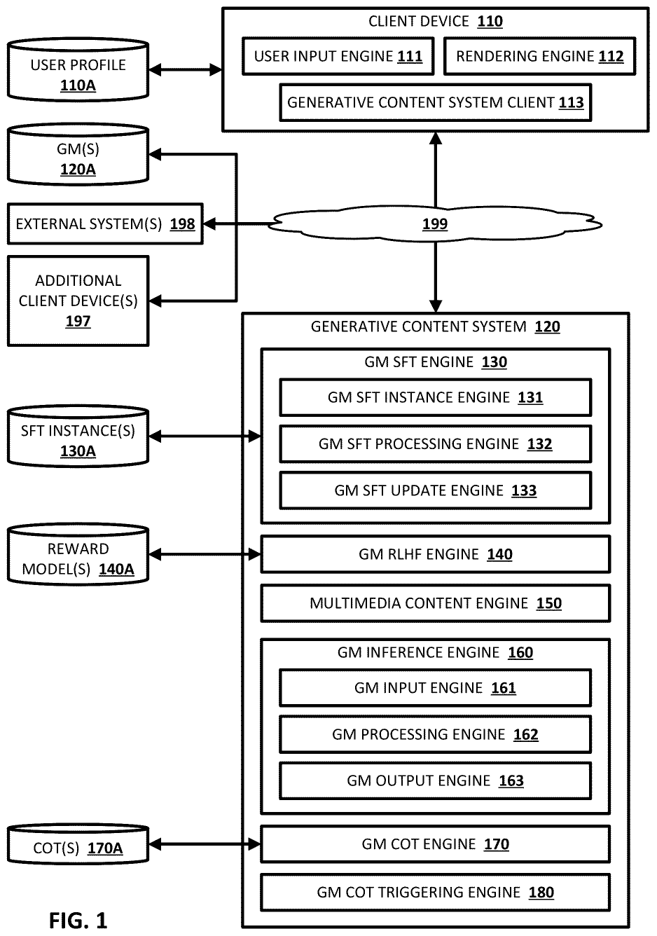

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a generative content system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, a video game console, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a conversation between a user of the client device 110 and an automated assistant executing at least in part at the client device 110, an indication of actions to be performed by an automated assistant executing at least in part at the client device 110, notifications, selectable graphical elements, and/or any other content and/or output described herein.

The client device 110 is illustrated in FIG. 1 as communicatively coupled over one or more networks 199 (e.g., any combination of WiFi, Bluetooth, or other local area networks (LANs); ethernet, the Internet, or other wide area networks (WANs); and/or any other wired or wireless networks). The generative content system 120 can be implemented by, for example, a high-performance server, a cluster of high-performance servers, and/or any other computing device that is remote from the client device 110. The generative content system 120 includes, in various implementations, a generative model (GM) supervised fine-tuning (SFT) engine 130, a GM reinforcement learning from human feedback (RLHF) engine 140, a multimedia content engine 150, a GM inference engine 160, a GM chain-of-thought (CoT) engine 170, and a CoT triggering engine 180. The GM SFT engine 130 can include various sub-engines, such as a GM SFT instance engine 131, a GM SFT training engine 132, and a GM SFT update engine 133. Further, the GM inference engine 160 can include various sub-engines, such as a GM input engine 161, a GM processing engine 162, and a GM output engine 163. Although FIG. 1 is depicted with respect to certain engines and sub-engines, it should be understood that is for the sake of example and is not meant to be limiting. For example, one or more of the engines and/or sub-engines depicted in FIG. 1 can be combined and/or omitted.

The client device 110 and/or the generative content system 120 can access various databases and/or systems. For instance, the client device 110A can access user profile database 110A that stores user profile data as described herein, GM(s) database 120A that stores one or more GMs as described herein, and/or CoT(s) database that stores one or more CoTs associated with gameplay of a video game by the user of the client device 110. Further, the client device 110 and/or the generative content system 120 can interact with one or more additional client devices 197 and/or one or more external systems 198 as described herein. However, in some implementations, the generative content system 120 may not have access to the user profile database 110A (e.g., when the generative content system 120 is implemented remotely from the client device 110A). Moreover, the generative content system 120 can also access SFT instance(s) database 130A that stores SFT instances for performing SFT for the one or more GMs stored in the GM(s) database 120A, and reward model(s) database 140A that stores one or more rewards models for utilization in reinforcement learning of the one or more GMs stored in the GM(s) database 120A. Although FIG. 1 is depicted with respect to certain databases and systems, it should be understood that is for the sake of example and is not meant to be limiting. For example, one or more of the databases and/or systems depicted in FIG. 1 can be combined and/or omitted.

Moreover, the client device 110 can execute the generative content system client 113. An instance of the generative content system client 113 can be an application that is separate from an operating system of the client device 110 (e.g., installed “on top” of the operating system)—or can alternatively be implemented directly by the operating system of the client device 110. The generative content system client 113 can communicate with the generative content system 120 via one or more of the networks 199 (e.g., as shown in FIG. 1). It should be understood that the generative content system client 113 can implement the generative content system 120 locally at the client device 110 via the generative content system client 113. However, it should also be understood that one or more aspects of the generative content system 120 can be implemented remotely from the client device 110 (e.g., exclusively at a high-performance server or cluster of high-performance servers), or both remotely the generative content system 120 and locally the client device 110 (e.g., via the generative content system client 113) in a distributed manner. For example, the generative content system 120 can initially update a so-called “pre-trained” GM (e.g., using the GM SFT engine 130 and/or the GM RLHF engine 140), then the generative content system client 113 can implement the multimedia content engine 150, the GM inference engine 160, the GM CoT engine 170, and/or the GM triggering engine 180 locally at the client device 110. Additionally, or alternatively, the generative content system 120 can implement the multimedia content engine 150, GM inference engine 160, the GM CoT engine 160, and/or the GM triggering engine 170.

Furthermore, the client device 110 and/or the generative content system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the generative content system 120 (e.g., over the one or more networks 199). As another example, a given client device can be utilized by multiple users in a shared setting (e.g., a group of users, a household, etc.).

As described herein, a GM can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

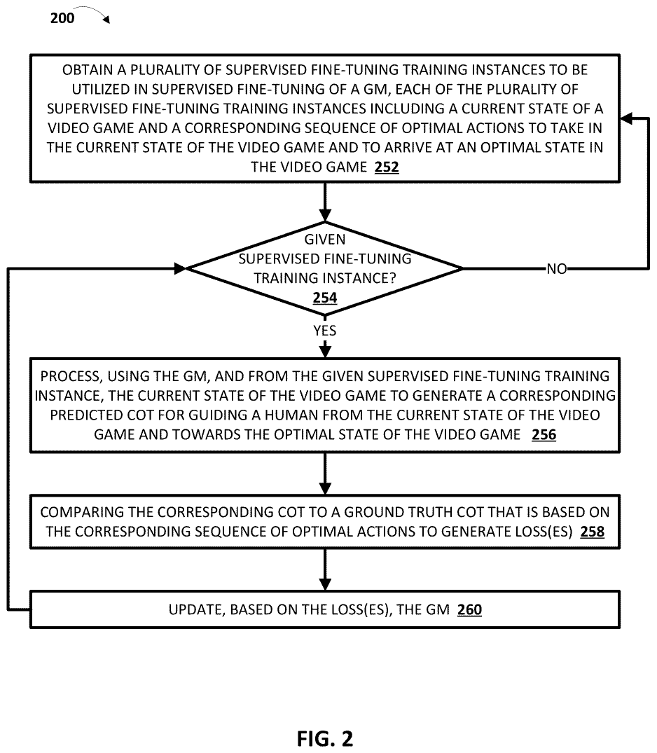

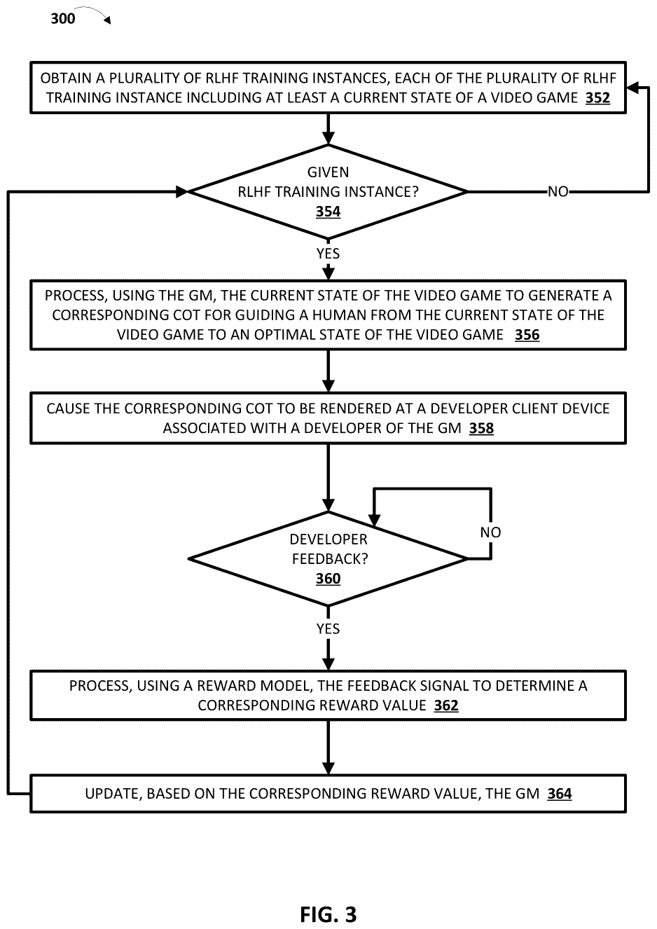

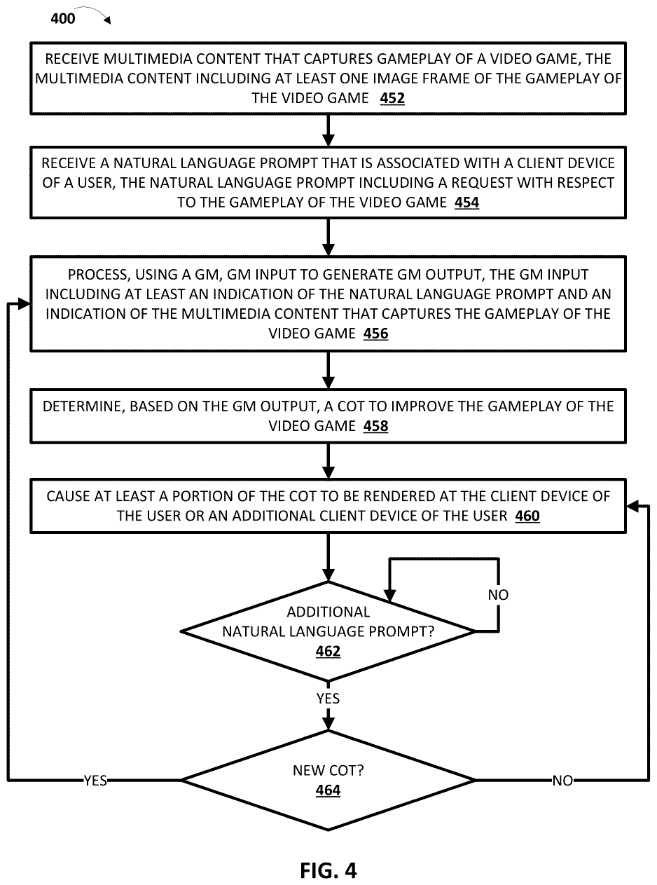

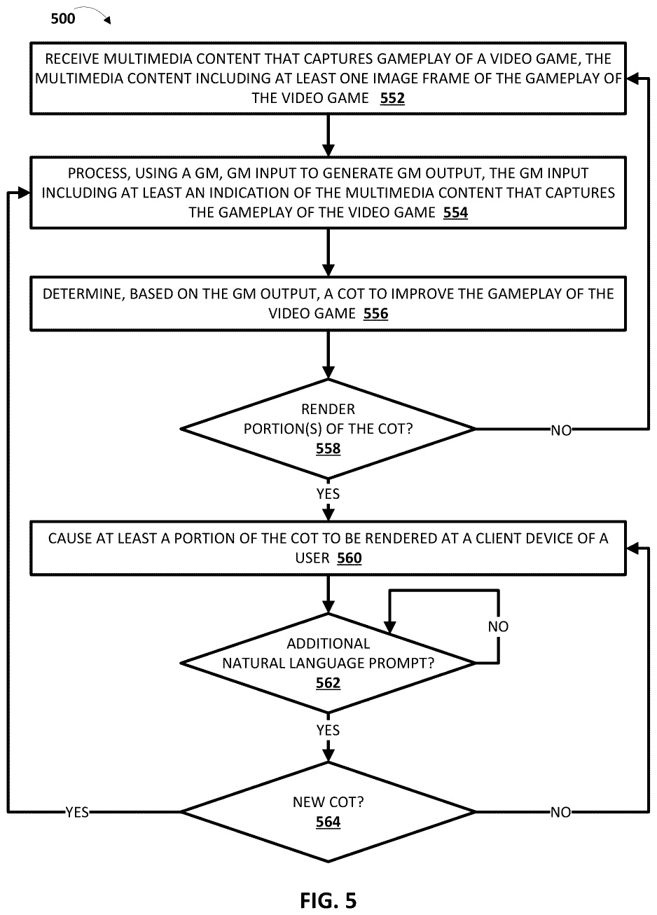

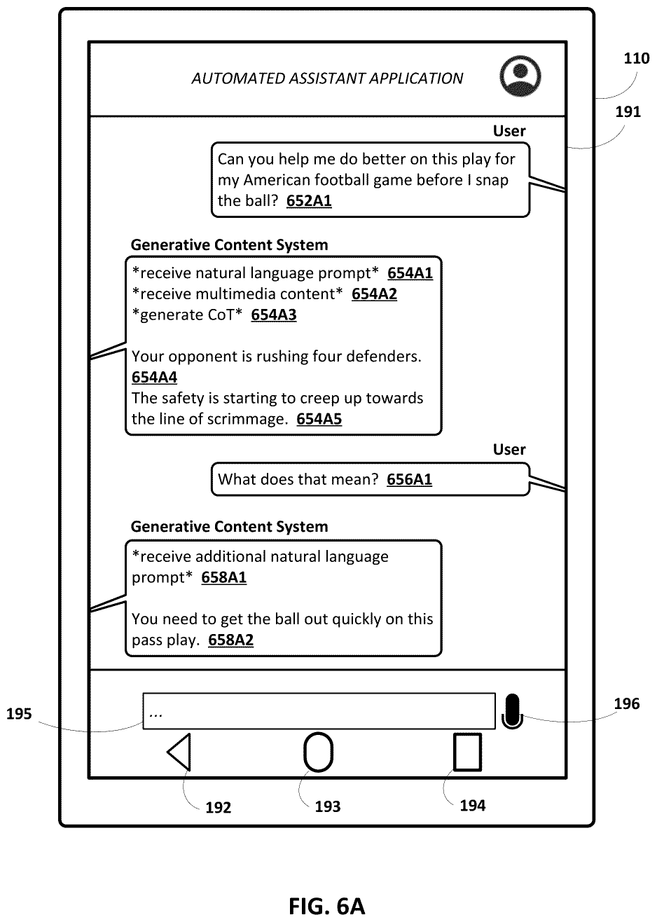

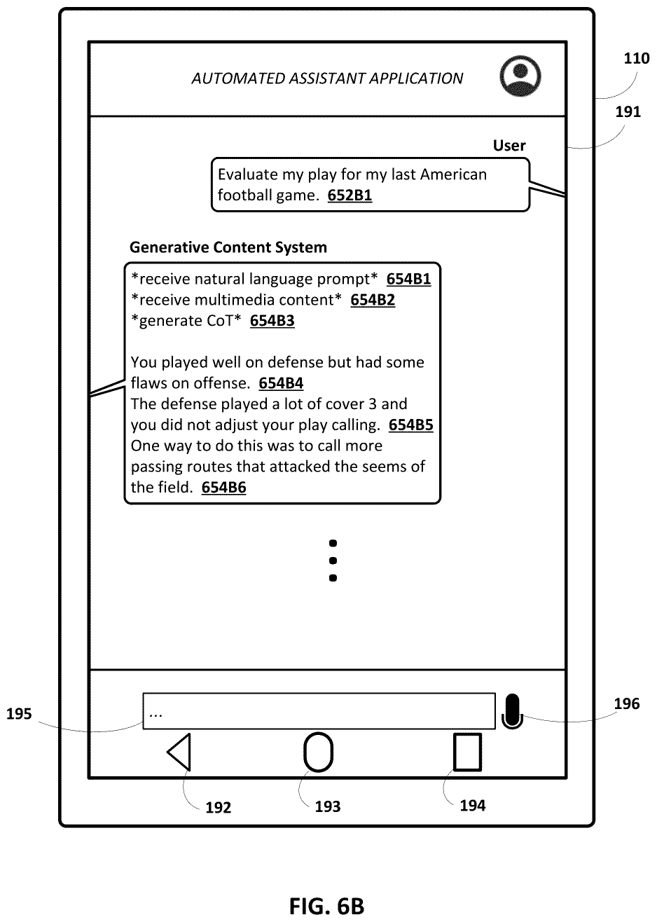

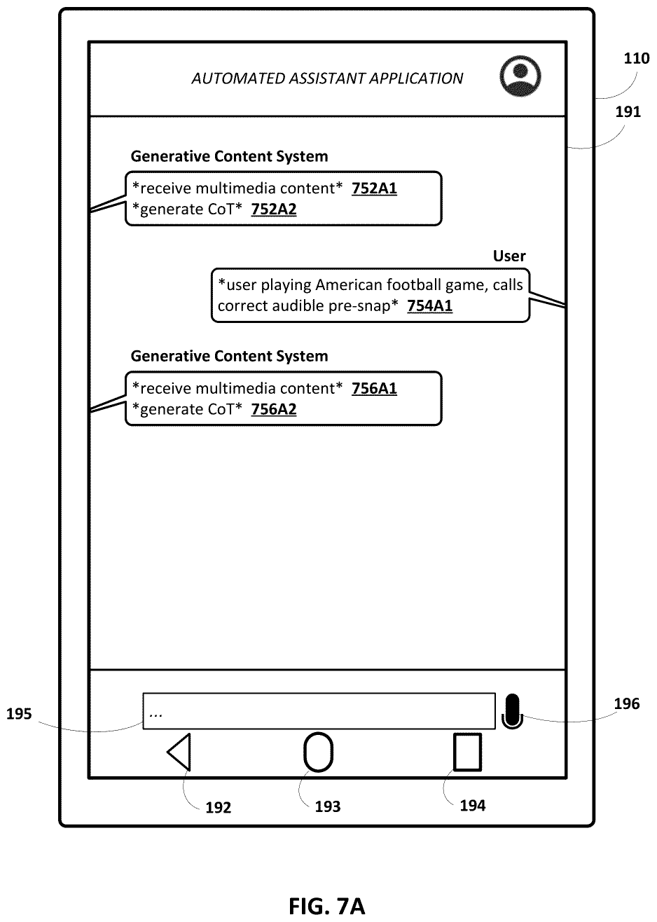

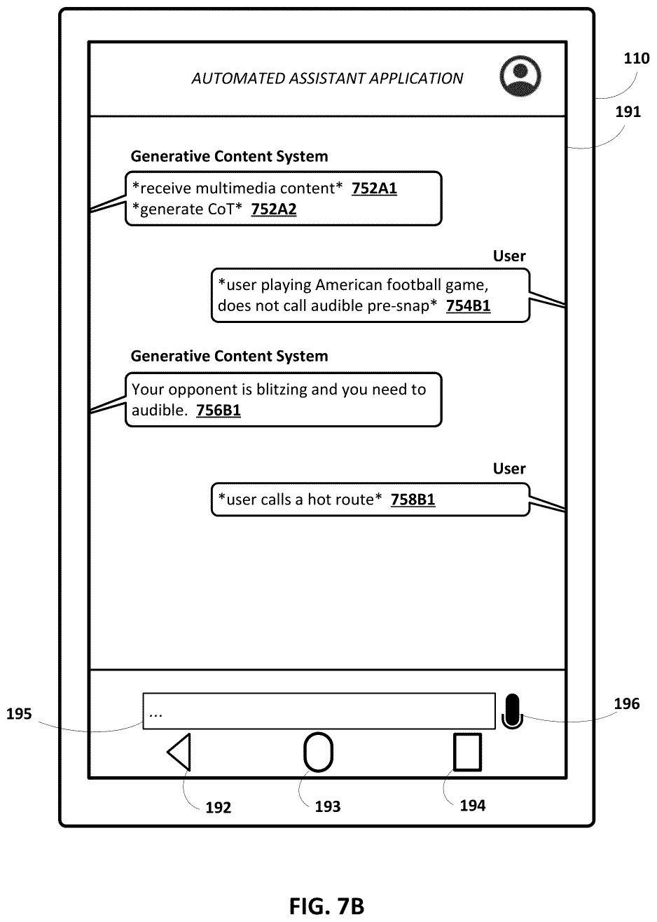

As described in more detail herein, the generative content system 120 can be utilized to refine a generative model (GM) using supervised fine-tuning (SFT) (e.g., as described in more detail in FIG. 2). For example, the GM can be refined using SFT that is performed in a supervised fashion that is guided by the user of the client device 110. Additionally, or alternatively, the GM can be refined using reinforcement learning from human feedback (RLHF) (e.g., as described in more detail in FIG. 3). For example, RLHF can be performed using a reinforcement learning-based reward model to refine the GM. By performing SFT and/or RLHF in the manner set forth herein, the generative content system 120 can be configured to generate a chain of thought (CoT) to improve the gameplay of a video game based on multimedia content that captures the gameplay of the video game. In some implementations, this CoT can be rendered to the user of the client device 110 in response to a natural language prompt (e.g., as described in more detail in FIG. 4). In additional or alternative implementations, the system can proactively render the CoT based on monitoring the gameplay of the video game (e.g., as described in more detail in FIG. 5). Some non-limiting examples of this functionality will be described in more detail in FIGS. 6A, 6B, 7A, and 7B. Additional description of the GM SFT engine 130, the GM RLHF engine 140, the multimedia content engine 150, the GM inference engine 160, and the GM CoT engine 170 is provided herein (e.g., with respect to FIGS. 2, 3, 4, 5, 6A-6B, and 7A-7B).

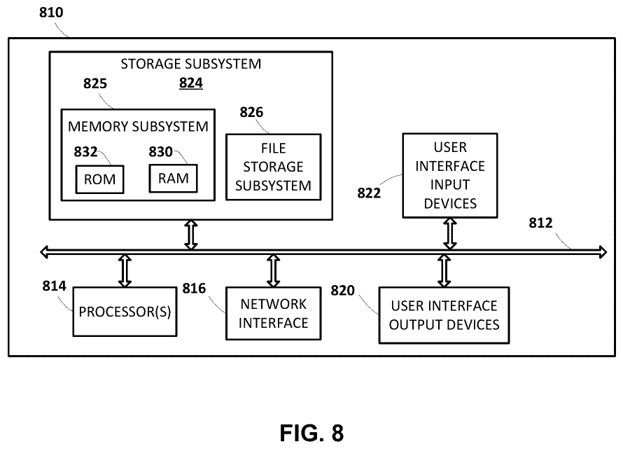

Turning now to FIG. 2, a flowchart illustrating an example method 200 of supervised fine-tuning (SFT) of a generative model (GM) to enable generation of chain-of-thought(s) (CoT(s)) for a video game is depicted. For convenience, the operations of the method 200 are described with reference to a system that performs the operations. This system of the method 200 includes at least one processor, memory, and/or other component(s) of computing device(s) (e.g., the client device 110 of FIG. 1, generative content system 120 of FIG. 1, computing device 810 of FIG. 8, and/or other computing device.). Moreover, while operations of the method 200 are shown in a particular order, this is not meant to be limiting. One or more operations may be reordered, omitted, and/or added.

At block 252, the system obtains a plurality of SFT fine-tuning training instances, each of the plurality of SFT fine-tuning training instances including a current state of a video game and a corresponding sequence of optimal actions to take in the current state of the video game and to arrive at an optimal state in the video game. For example, the system can cause the GM SFT instance engine 131 of the GM SFT engine 130 to obtain the plurality of SFT training instances. The current state may include at least one image frame of gameplay of the video game and/or state data for the current state of gameplay of the video game. Further, the sequence of optimal actions can include an optimal sequence of actions for the user to perform so as to arrive at the optimal state in the video game. For instance, assume that the user is playing a game of chess. In this instance, the current state of the user's game of chess can include image(s) and/or video(s) capturing pieces on the chess board, a position on the chess board, etc. Further, the sequence of optimal actions to take in the current state can include the best chess moves to improve the user's position.

At block 254, the system determines whether there is a given SFT training instance in the plurality of SFT fine-tuning training instances. If, at an iteration of block 254, the system determines that there is not a given SFT training instance in the plurality of SFT training instances, then the system returns to block 252. If, at an iteration of block 254, the system determines there is a given SFT training instance in the plurality of SFT training instances, the system proceeds to block 256.

At block 256, the system processes, using the GM, and from the given SFT training instance, the current state of the video game to generate a corresponding predicted CoT for guiding a human from the current state of the video game and towards the optimal state of the video game. For example, the system can cause the GM SFT processing engine 132 of the GM SFT engine 130 to process, using the GM, the current state of the video game to generate the corresponding predicted CoT for guiding the human from the current state of the video game and towards the optimal state of the video game. Continuing with the above instance of the user playing a game of chess, the GM SFT processing engine 132 can process, using the GM, the image(s) and/or video(s) of the user's game of chess (e.g., the current state of the user's game of chess) to generate the corresponding predicted CoT for guiding the human from the current position to the improved position in the user's game of chess.

At block 258, the system compares the corresponding predicted CoT to a ground truth CoT that is based on the corresponding sequence of optimal actions to generate one or more losses. For example, the system can cause the GM SFT update engine 133 of the GM SFT engine 130 to compare the corresponding predicted CoT to a ground truth CoT that is based on the corresponding sequence of optimal actions to generate one or more losses. Continuing with the ongoing example of the user playing a game of chess, the GM SFT update engine 133 can compare the corresponding predicted CoT (e.g., improved position in the user's game of chess) to a ground truth CoT that is based on the improved position.

At block 260, the system updates, based on one or more of the losses, the GM. For example, the system can cause the GM SFT update engine 133 of the GM SFT engine 130 to update the GM based on one or more of the losses using backpropagation. The system returns to block 254 and proceeds with an additional iteration of the method 200 to continue to refine the GM based on additional SFT training instances.

Although the method 200 of FIG. 2 is described with respect to performing SFT to further improve the GM, it should be understood that SFT is not required. For instance, in some implementations, RLHF may be sufficient to produce meaningful outputs from the GM for a video game of interest and the operations of the method 200 of FIG. 2 may be omitted.

Turning now to FIG. 3, a flowchart illustrating an example method 300 of performing reinforcement learning from human feedback (RLHF) for a generative model (GM) to enable generation of chain-of-thought(s) (CoT(s)) for a video game is depicted. For convenience, the operations of the method 300 are described with reference to a system that performs the operations. This system of the method 300 includes at least one processor, memory, and/or other component(s) of computing device(s) (e.g., the client device 110 of FIG. 1, generative content system 120 of FIG. 1, computing device 810 of FIG. 8, and/or other computing device.). Moreover, while operations of the method 300 are shown in a particular order, this is not meant to be limiting. One or more operations may be reordered, omitted, and/or added.

At block 352, the system obtains a plurality of RLHF training instances, each of the plurality of RLHF training instances including at least a current state of the video game. For example, the system can cause the RLHF engine 140 of the generative content system 120 to obtain the plurality of RLHF training instances. The current state may include at least one image frame of gameplay of the video game and/or state data for the current state of gameplay of the video game. For instance, assume that the user is playing a game of chess. In this instance, the current state of the user's game of chess can include image(s) and/or video(s) capturing pieces on the chess board, a position on the chess board, etc.

At block 354, the system determines whether there is a given RLHF training instance in the plurality of RLHF training instances. If, at an iteration of block 354, the system determines that there is not a given RLHF training instance in the plurality of RLHF training instances, then the system returns to block 352. If, at an iteration of block 354, the system determines there is a given RLHF training instance in the plurality of RLHF training instances, the system proceeds to block 356.

At block 356, the system processes, using the GM, and from the given RLHF training instance, the current state of the video game to generate a corresponding CoT for guiding a human from the current state of the video game to an optimal state of the video game. For example, the system can cause the GM input engine 161 of the GM inference engine 160 to generate GM input based on the current state of the video game, such as a tokenized version of the at least one image frame of gameplay of the video game and/or tokenized state data for the current state of gameplay of the video game. Further, the system can cause the GM processing engine 162 of the GM inference engine 160 to process, using the GM, the GM input to generate GM output. Moreover, the system can cause the GM output engine 163 of the GM inference engine 160 to determine, based on the GM output, the corresponding CoT for guiding the human from the current state of the video game to the optimal state of the video game. Continuing with the above instance of the user playing a game of chess, the corresponding CoT can include information about the current position, such as strengths of the current position, weaknesses of the current position, etc., in order to generate the corresponding CoT for guiding the human from the current position to the improved position in the user's game of chess.

At block 358, the system causes the corresponding CoT to be rendered at a developer client device associated with a developer of the GM. For example, the system can cause the corresponding CoT to be visually rendered at the developer client device via a display of the developer client device and/or audibly rendered at the developer client device via a speaker of the developer client device. Continuing with the above instance of the user playing a game of chess, the corresponding CoT can be rendered at the developer client device and along with the chess board and pieces in the user's game of chess or the chess board and pieces in the user's game can be viewed at a separate client device that is in addition to the developer client device.

At block 360, the system determines whether developer feedback is received at the developer client device and with respect to the corresponding CoT. For instance, the developer feedback can be received as touch input (e.g., via a selection of a thumbs up button or a thumbs down button), typed input (e.g., via a physical or virtual keyboard of the developer client device), spoken input (e.g., via audio input device(s) of the developer client device, and/or via a microphone of the developer client device), and/or by other means. If, at an iteration of block 360, the system determines that developer feedback is not received at the developer client device and with respect to the corresponding CoT, then the system continues monitoring for developer feedback with respect to the corresponding CoT. If, at an iteration of block 360, the system determines that developer feedback is received at the developer client device and with respect to the corresponding CoT, then the system proceeds to block 362.

At block 362, the system processes, using a reward model, the feedback signal to determine a corresponding reward value. The reward model can be stored, for example, in the reward model(s) database 140A. Further, the reward corresponding reward value can be a numerical score reflecting how helpful and aligned the corresponding CoT for guiding the human from the current state of the video game towards the optimal state of the video game. This score is then used to update the GM's parameters, encouraging it to produce CoTs that are more likely to receive positive feedback in the future. Continuing with the above instance of the user playing a game of chess, if the corresponding CoT guides the human to an improved position in the user's game of chess, then the reward model can process the developer feedback to determine a reward value that is a numerical score reflecting how confident the corresponding CoT was that the human moved to the improved position in the user's game of chess.

At block 364, the system updates, based on the corresponding reward value, the GM. For example, the system can cause the RLHF engine 140 to update the GM based on the corresponding reward value. The system returns to block 354 and proceeds with an additional iteration of the method 300 to continue to refine the GM based on additional RLHF training instances.

Although the method 300 of FIG. 3 is described with respect to performing RLHF to further improve the GM, it should be understood that RLHF is not required. For instance, in some implementations, SFT may be sufficient to produce meaningful outputs from the GM for a video game of interest and the operations of the method 300 of FIG. 3 may be omitted.

Turning now to FIG. 4, a flowchart illustrating an example method 400 of using a generative model (GM) to generate chain-of-thought(s) (CoT(s)) for a video game and in response to receiving natural language prompt(s) from a client device of a user is depicted. For convenience, the operations of the method 400 are described with reference to a system that performs the operations. This system of the method 400 includes at least one processor, memory, and/or other component(s) of computing device(s) (e.g., the client device 110 of FIG. 1, generative content system 120 of FIG. 1, computing device 810 of FIG. 8, and/or other computing device.). Moreover, while operations of the method 400 are shown in a particular order, this is not meant to be limiting. One or more operations may be reordered, omitted, and/or added.

At block 452, the system receives multimedia content that captures gameplay of a video game, the multimedia content including at least one image frame of the gameplay of the video game. For example, the system can cause the multimedia content engine 150 of the generative content system 120 to receive the multimedia content that captures the gameplay of the video game. In some implementations, the multimedia content may further include state data for the current state of gameplay of the video game. Notably, the state data can describe characteristics of the scene, the object(s) included therein, the player(s) therein, etc. that may not be readily perceptible from the at least one image frame alone.

At block 454, the system receives a natural language prompt that is associated with a client device of a user, the natural language prompt including a request with respect to the gameplay of the video game. The natural language prompt can be detected via, for example, the user input engine 111 of the client device 110 of the user. In some implementations, the multimedia content may be received from the client device of the user from which the natural language prompt is received, whereas in other implementations, the multimedia content may be received from an additional client device associated with the user that is in addition to the client device of the user. Further, in some implementations, the natural language prompt may be received during gameplay of the video game, whereas in other implementations, the natural language prompt may be received subsequent to completion of the gameplay.

At block 456, the system processes, using a generative model (GM), GM input to generate GM output, the GM input including at least an indication of the natural language prompt and an indication of the multimedia content that captures the gameplay of the video game. For example, the system can cause the GM input engine 161 of the GM inference engine 160 to generate GM input based on the natural language prompt and the multimedia content that captures the gameplay of video game. The GM input can include, for instance, a tokenized version of the at least one image frame of gameplay of the video game and/or tokenized state data for the current state of gameplay of the video game, and include a tokenized version of the natural language prompt. Further, the system can cause the GM processing engine 162 of the GM inference engine 160 to process, using the GM, the GM input to generate GM output. The GM output can include, for instance, a probability distribution over a sequence of optimal actions of a CoT that guides the user from their current state to the optimal state, a probability distribution over one or more CoTs that guides the user from their current state to the optimal state, a co-occurrence distribution that indicates co-occurrences between different actions, and/or CoT(s) for guiding the user from their current state to the optimal state of the video game.

At block 458, the system determines, based on the GM output, a CoT to improve the gameplay of the video game. For example, the system can cause the GM output engine 163 of the GM inference engine 160 to determine, based on the GM output, the CoT for guiding the user from their current state to the optimal state of the video game. Notably, the CoT can include, for instance, a step-by-step explanation of the user's current state, the optimal state, and the actions needed to get from the current state to the optimal state. It can also include information about any of the user's opponents, the strengths and weaknesses of both the user and their opponents, and the likely outcomes of different actions. The CoT can be in a natural language format that is easy for the user to understand. However, it should be noted that the CoT can vary on the video game captured in the multimedia content, a type of video game captured in the multimedia content (e.g., strategy games, sports games, role-playing games, etc.), etc.

At block 460, the system causes at least a portion of the CoT to be rendered at the client device of the user or an additional client device of the user. For example, the system can cause the GM CoT engine 170 of the generative content system 120 to cause the at least a portion of the CoT to be rendered at the client device of the user or the additional client device of the user. Notably, the portion(s) of the CoT that are rendered at the client device can include a current understanding of the user's current situation, a current understanding of any of the user's opponents, etc., but may not include the precise sequence of actions that can be carried out to reach the optimal state or the optimal state itself. Thus, the portion(s) of the CoT that are rendered can guide the user from their current state to the optimal state without explicitly presenting the precise sequence of actions that can be carried out to reach the optimal state or the optimal state itself.

At block 462, the system determines whether an additional natural language prompt that is associated with the client device of the user is received. If, at an iteration of block 462, the system determines an additional natural language prompt is not received, then the system continues monitoring for the additional natural language prompt at block 462. If, at an iteration of block 462, the system determines that the additional natural language prompt is received, then the system proceeds to block 464.

At block 464, the system determines, based on the additional natural language prompt, whether to generate a new CoT. The system can determine whether to generate a new CoT, for example, based on content of the additional natural language prompt and/or additional portion(s) of the CoT that have not yet been rendered. For example, and as noted above, the portion(s) of the CoT that are initially rendered may not include the precise sequence of actions that can be carried out to reach the optimal state or the optimal state itself. Accordingly, if the additional natural language prompt requests this information, then the system need not generate a new CoT. Otherwise, the system may need to generate a new CoT.

If, at an iteration of block 464, the system determines not to generate a new CoT, then the system returns to block 460 and causes additional portion(s) of the CoT to be rendered at the client device of the user or the additional client device of the user. The system can continue with the method 400 of FIG. 4. Thus, the user can continue to interact with the system by providing subsequent natural language prompts that request additional portion(s) of the CoT to be rendered at the client device of the user or the additional client device of the user and/or that require new CoT(s) to be generated.

If, at an iteration of block 464, the system determines to generate a new CoT, then the system returns to block 456. At a subsequent iteration of block 456, the system can process, using the GM, additional GM input to generate additional GM output. The additional GM input can include, for instance, an indication of the additional natural language prompt and an indication of the multimedia content that captures the gameplay of the video game (or an indication of additional multimedia content that captures the gameplay of the video game). The system can continue with the method 400 of FIG. 4.

Although the method 400 of FIG. 4 is described with respect to CoT(s) being rendered in response to natural language prompt(s) received from the client device of the user, it should be understood that is for the sake of example and is not meant to be limiting. For example, in additional or alternative implementations (e.g., as described with respect to FIG. 5), the system can additionally, or alternatively, proactively render CoT(s) based on monitoring the gameplay of the video game.

Turning now to FIG. 5, a flowchart illustrating an example method 500 of using a generative model (GM) to generate chain-of-thought(s) (CoT(s)) for a video game and determining whether to proactively render the CoT(s) at a client device of a user is depicted. For convenience, the operations of the method 500 are described with reference to a system that performs the operations. This system of the method 500 includes at least one processor, memory, and/or other component(s) of computing device(s) (e.g., the client device 110 of FIG. 1, generative content system 120 of FIG. 1, computing device 810 of FIG. 8, and/or other computing device.). Moreover, while operations of the method 500 are shown in a particular order, this is not meant to be limiting. One or more operations may be reordered, omitted, and/or added.

At block 552, the system receives multimedia content that captures gameplay of a video game, the multimedia content including at least one image frame of the gameplay of the video game. For example, the system can cause the multimedia content engine 150 of the generative content system 120 to receive the multimedia content that captures the gameplay of the video game. In some implementations, the multimedia content may further include state data for the current state of gameplay of the video game. Notably, the state data can describe characteristics of the scene, the object(s) included therein, the player(s) therein, etc. that may not be readily perceptible from the at least one image frame alone.

At block 554, the system processes, using a generative model (GM), GM input to generate GM output, the GM input including at least an indication of the multimedia content that captures the gameplay of the video game. The system can process the GM input to generate the GM output in the same or similar manner described with respect to block 456 of the method 400 of FIG. 4. However, it should be noted that the GM input does include any indication of any natural language prompt like the GM input described with respect to block 456 of the method 400 of FIG. 4.

At block 556, the system determines, based on the GM output, a CoT to improve the gameplay of the video game. The system can determine the CoT to improve the gameplay in the same or similar manner described with respect to block 458 of the method 400 of FIG. 4.

At block 558, the system determines whether to render portion(s) of the CoT at a client device of a user. For example, the system can cause the GM CoT triggering engine 180 of the generative content system 120 to determine whether to render portion(s) of the CoT at a client device of the user. The GM CoT triggering engine 180 can determine whether to render the portion(s) of the CoT at the client device of the user based on, for example, a current state of the gameplay and/or the CoTs generated during the current iteration of the method 500. For instance, if the GM CoT triggering engine 180 determines that a predicted action that is likely to be performed by the user deviates from the generated CoT, then the GM CoT triggering engine 180 can cause the portion(s) of the CoT to be rendered at the client device. Also, for instance, if the GM CoT triggering engine 180 determines that the user has paused in the gameplay for a threshold duration of time, then the GM CoT triggering engine 180 can cause the portion(s) of the CoT to be rendered at the client device. Otherwise, the GM CoT triggering engine 180 may refrain from causing any portions of the CoT to be rendered.

If, at an iteration of block 558, the system determines not to render portion(s) of the CoT at the client device of the user, then the system returns to block 552 and continues with an additional iteration of the method 500. In some implementations, the system may wait to return to block 552 to perform an additional iteration of the method 500 until the CoT is no longer relevant to the current state of the gameplay of the video game. If, at an iteration of block 558, the system determines to render portion(s) of the CoT at the client device of the user, then the system proceeds to block 560.

At block 560, the system causes at least a portion of the CoT to be rendered at a client device of the user. The system can cause the at least a portion of the CoT to be rendered at the client device of the user in the same or similar manner described with respect to block 460 of the method 400 of FIG. 4.

At block 562, the system determines whether an additional natural language prompt that is associated with the client device of the user is received. If, at an iteration of block 562, the system determines an additional natural language prompt is not received, then the system continues monitoring for the additional natural language prompt at block 562. If, at an iteration of block 562, the system determines that the additional natural language prompt is received, then the system proceeds to block 564.

At block 564, the system determines, based on the additional natural language prompt, whether to generate a new CoT. The system can determine whether to generate a new CoT, for example, based on content of the additional natural language prompt and/or additional portion(s) of the CoT that have not yet been rendered. The system can determine whether to generate a new CoT in the same or similar manner described with respect to block 464 of the method 400 of FIG. 4.

If, at an iteration of block 564, the system determines not to generate a new CoT, then the system returns to block 560 and causes additional portion(s) of the CoT to be rendered at the client device of the user or the additional client device of the user. The system can continue with the method 500 of FIG. 5. Thus, the user can continue to interact with the system by providing subsequent natural language prompts that request additional portion(s) of the CoT to be rendered at the client device of the user and/or that require new CoT(s) to be generated.

If, at an iteration of block 564, the system determines to generate a new CoT, then the system returns to block 554. At a subsequent iteration of block 554, the system can process, using the GM, additional GM input to generate additional GM output. The additional GM input can include, for instance, an indication of the additional natural language prompt and an indication of the multimedia content that captures the gameplay of the video game (or an indication of additional multimedia content that captures the gameplay of the video game). The system can continue with the method 500 of FIG. 5.

Turning now to FIGS. 6A and 6B, various non-limiting examples of utilizing a generative model (GM) to generate chain-of-thought(s) (CoT(s)) for a video game and in response to receiving natural language prompt(s) from a client device of a user are depicted. FIGS. 6A and 6B each depict a client device 110 (e.g., an instance of the client device 110 from FIG. 1) having a display 191. Although the client device 110 of FIGS. 6A and 6B is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device.

The display 191 of the client device 110 in FIGS. 6A and 6B further includes a textual input interface element 195 that the user may select to generate user input via a keyboard (virtual or real) or other touch and/or typed input, and a spoken input interface element 196 that the user may select to generate user input via microphone(s) of the client device 110. In some implementations, the user may generate user input via the microphone(s) without selection of the spoken input interface element 196. For example, active monitoring for audible user input via the microphone(s) may occur to obviate the need for the user to select the spoken input interface element 196. In some of those and/or in other implementations, the spoken input interface element 196 may be omitted. Moreover, in some implementations, the textual input interface element 195 may additionally and/or alternatively be omitted (e.g., the user may only provide audible user input). The display 191 of the client device 110 in FIGS. 6A and 6B also includes system interface elements 192, 193, 194 that may be interacted with by the user to cause the client device 110 to perform one or more actions.

Referring specifically to FIG. 6A, assume that a user of the client device 110 is playing a game of American football on a game console, and that the user provides a natural language prompt 652A1 of “Can you help me do better on this play for my American football game before I snap the ball?” to the client device 110. Further assume that an automated assistant executing at least in part at the client device 110 has access to a generative content system (e.g., generative content system 120) as described herein. As shown in FIG. 6A, and in response to providing the natural language prompt 652A1, the generative content system can receive the natural language prompt 652A1 as indicated at 654A1, receive multimedia content that captures gameplay of the American football game from the game console as indicated at 654A2, and generate a CoT based on processing at least the natural language prompt 652A1 and the multimedia content that captures the gameplay as indicated at 654A3.

Further assume that the generative content system renders portions of the CoT at the display 191 of the client device 110, such as a first portion of the CoT 654A4 of “Your opponent is rushing four defenders” and a second portion of the CoT 654A5 of “The safety is starting to creep up towards the line of scrimmage”. Notably, the first portion of the CoT 654A4 and/or the second portion of the CoT 654A5 can be presented in response to the natural language prompt 652A1, but do not include the actual precise sequence of actions that can be carried out to reach the optimal state. Put another way, in this example, the CoT is walking the user through how to read the defense at the line of scrimmage of the American football game. By walking the user through how to read the defense at the line of scrimmage, the generative content system is guiding the user to a particular target for a pass play that will be open quickly, a particular audible to make a at the line of scrimmage to ensure that a particular target for a pass play will be open quickly, and/or any other type of action that is specific to the American football game for dealing with a blitz.

Further assume that the user provides an additional natural language prompt 656A1 of “What does that mean?” to the client device 110 in order to determine further details about why the generative content system has provided the first portion of the CoT 654A4 of and the second portion of the CoT 654A5. Accordingly, in this example, and in response to the additional natural language prompt 656A1, the system can receive the additional natural language prompt 656A1 as indicated at 658A1, and render an additional portion of the CoT at the display 191 of the client device 110, such as a third portion of the CoT 658A2 of “You need to get the ball out quickly on this pass play.”

Referring specifically to FIG. 6B, assume that a user of the client device 110 has completed playing a game of American football on a game console, and that the user provides a natural language prompt 652B1 of “Evaluate my play for my last American football game” to the client device 110. Further assume that an automated assistant executing at least in part at the client device 110 has access to a generative content system (e.g., generative content system 120) as described herein. As shown in FIG. 6B, and in response to providing the natural language prompt 652B1, the generative content system can receive the natural language prompt 652B1 as indicated at 654B1, receive multimedia content that captures gameplay of the American football game from the game console as indicated at 654B2, and generate a CoT based on processing at least the natural language prompt 652B1 and the multimedia content that captures the gameplay as indicated at 654B3.

Further assume that the generative content system the CoT at the display 191 of the client device 110, such as a first portion of the CoT 654B4 of “You played well on offense but had some flaws on defense”, a second portion of the CoT 654B5 of “The defense played a lot of cover 3 and you did not adjust your play calling”, and a third portion of the CoT 654B6 of “One way to do this was to call more passing routes that attacked the seems of the field”. Notably, the CoT that is presented in response to the natural language prompt 652B1 may walk the user through certain plays, what the user could have done to improve on those certain plays, etc. and refrain from withholding any portion(s) of the CoT in this example since the game of American football is already completed. The user can continue interacting with the generative content system as desired.

Although the examples of FIGS. 6A and 6B are described with respect to American football, it should be understood that these examples are not meant to be limiting. Rather, it should be understood that the techniques contemplated herein can be applied to any video games, and the CoTs that are generated can be adapted based on particular video game and/or based on a variety of data available for the particular video game at a given time. Further, although the examples of FIGS. 6A and 6B are described with respect to the natural language prompts being received by the client device 110 and the American football game being played at a separate game console, it should be understood that is for the sake of example and is not meant to be limiting. Rather, it should be understood that the natural language prompts received, and gameplay of a video can be performed at the same client device.

Turning now to FIGS. 7A and 7B, various non-limiting examples of utilizing a generative model (GM) to generate chain-of-thought(s) (CoT(s)) for a video game and determining whether to proactively render the CoT(s) at a client device of a user are depicted. FIGS. 7A and 7B each depict the client device 110 (e.g., an instance of the client device 110 from FIG. 1) described above with respect to FIGS. 6A and 6B.

Referring specifically to FIG. 7A, assume that a user of the client device 110 is playing a game of American football on a game console, and that an automated assistant executing at least in part at the client device 110 has access to a generative content system (e.g., generative content system 120) as described herein. As shown in FIG. 7A, further assume that the generative content system is monitoring gameplay of the American football game such that the generative content system continuously receives multimedia content that captures the gameplay of the American football game from the game console as indicated at 752A1 and generates a CoT based on such continuous gameplay monitoring and processing thereof as indicated at 752A2.

Further assume that a current state of the American football game indicates that the user is on offense and a play is about to begin. However, and based on the user reading the defense, assume that the user calls a correct audible pre-snap as indicated at 754A1, which is consistent with the CoT that was generated. Accordingly, in this example, the generative content system may refrain from causing any portions of the CoT to be rendered at the display 191 of the client device 110 since the user's gameplay is consistent with the CoT that was generated.

In contrast, and referring specifically to FIG. 7B, instead assume that the user does not call the correct audible pre-snap as indicated at 754B1, which is inconsistent with the CoT that was generated. Accordingly, in this example, the generative content system may cause at least a portion of the CoT to be rendered at the display 191 of the client device 110 before the user takes the snap, such as a portion of the CoT 756B1 of “Your opponent is blitzing and you need to audible”. As a result of the portion of the CoT 756B1 being rendered at the display 191 of the client device 110, the user can then call a hot route as indicated at 758B1 to account for the blitz of the opponent.

Although the examples of FIGS. 7A and 7B are described with respect to American football, it should be understood that these examples are not meant to be limiting. Rather, it should be understood that the techniques contemplated herein can be applied to any video games, and the CoTs that are generated can be adapted based on particular video game and/or based on a variety of data available for the particular video game at a given time. Further, although the examples of FIGS. 7A and 7B are described with respect to the natural language prompts being received by the client device 110 and the American football game being played at a separate game console, it should be understood that is for the sake of example and is not meant to be limiting. Rather, it should be understood that the natural language prompts received and gameplay of a video can be performed at the same client device.

Turning now to FIG. 8, a block diagram of an example computing device 810 that may optionally be utilized to perform one or more aspects of techniques described herein. In some implementations, one or more of a client device, remote system component(s), and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods disclosed herein, as well as to implement various components depicted in FIG. 1.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes: receiving multimedia content that captures gameplay of a video game, the multimedia content including at least one image frame of the gameplay of the video game; receiving a natural language prompt that is associated with a client device of a user, the natural language prompt including a request with respect to the gameplay of the video game; processing, using a generative model, GM input to generate GM output, the GM input including at least an indication of the natural language prompt and an indication of the multimedia content that captures the gameplay of the video game; determining, based on the GM output, a chain of thought (CoT) to improve the gameplay of the video game; and causing at least a portion of the CoT to be rendered at the client device of the user.

These and other implementations of technology disclosed herein can optionally include one or more of the following features.

In some implementations, the user can be playing the video game, and the natural language prompt can be received while the user is playing the video game.

In some versions of those implementations, the portion of the CoT can be rendered without interrupting gameplay of the user.

In additional or alternative versions of those implementations, the portion of the CoT can interrupt gameplay of the user.

In additional or alternative versions of those implementations, the request can be to get from a current state of the video game to a final state of the video game, and at least the portion of the CoT that is rendered can include the final state of the video game.

In some further versions of those additional or alternative implementations, the method can further include: receiving an additional natural language prompt that is associated with the client device of the user, the additional natural language prompt including an additional request for an additional portion of the CoT that is associated with the final state of the video game; and in response to receiving the additional natural language prompt, causing the additional portion of the CoT to be rendered at the client device of the user.

In additional or alternative versions of those implementations, the gameplay of the video game can be at the client device of the user, and the portion of the CoT can be rendered at the client device of the user.

In additional or alternative implementations, the gameplay of the video game can be at an additional client device, that is different than the client device of the user, and the portion of the CoT can be rendered at the client device of the user.

In some implementations, the user may have completed playing the video game, and the natural language prompt can be received subsequent to the user playing the video game.

In some versions of those implementations, the request can be to analyze the user's gameplay of the video game, and the CoT can include suggested improvements to the gameplay of the video game.

In some implementations, an additional user, that is in addition to the user, can be playing the video game, and the request can be to analyze the additional user's gameplay of the video game to determine why the additional user performed a particular action in the gameplay of the video game.

In some versions of those implementations, the CoT can include an indication of why the additional user performed the particular action in the gameplay of the video game and an indication of how the additional user could improve gameplay of the video game.

In some implementations, the method can further include, prior to receiving the natural language prompt, supervising fine-tuning of the generative model. Supervising fine-tuning the GM can include: obtaining a plurality of SFT training instances, each SFT training instance including a current state of the video game and a corresponding sequence of optimal actions to take in the current state of the video game and to arrive an optimal state in the video game; processing, using the GM, the current state of the video game to generate a corresponding predicted CoT for guiding a human from the current state of the video game and towards the optimal state of the video game; comparing the corresponding predicted CoT to a ground truth COT that is based on the corresponding sequence of optimal actions to generate one or more losses; and updating, based on one or more of the losses, the GM.

In some versions of those implementations, the current state of the video game can include at least one image frame of gameplay of the video game and/or can include state data for the current state of gameplay of the video game.

In additional or alternative versions of those implementations, processing the current state of the video game to generate the corresponding predicted CoT for guiding the human from the current state of the video game towards the optimal state of the video game can include: generating a plurality of possible actions for the human from the current state of the video game; and for each possible action of the plurality of the possible actions: processing, using the GM, the current state of the video game to generate the corresponding predicted CoT for guiding the human from the current state of the video game towards the optimal state of the video game; and aggregating a plurality of the corresponding CoTs.

In some implementations, the method can further include, prior to receiving the natural language prompt: performing reinforcement learning from human feedback (RLHF) of the generative model. Performing RLHF can include: obtaining a plurality of RLHF training instances, each RLHF training instance including at least a current state of the video game; processing, using the GM, the current state of the video game to generate a corresponding CoT for guiding a human from the current state of the video game to an optimal state of the video game; causing the corresponding CoT to be rendered at a developer client device associated with a developer of the GM; receiving, from the developer and via the developer client device, a feedback signal with respect to the corresponding CoT; and updating, based on the feedback signal, the GM.

In some versions of those implementations, updating the GM based on the feedback signal can include: processing, using a reward model, the feedback signal to determine a corresponding reward value; and updating, based on the corresponding reward value, one or more parameters associated with the GM.

In some implementations, a method implemented by one or more processors is provided and includes: receiving multimedia content that captures gameplay of a video game, the multimedia content including at least one image frame of the gameplay of the video game; processing, using a generative model (GM), GM input to generate GM output, the GM input including at least an indication of the multimedia content that captures the gameplay of the video game; determining, based on the GM output, a chain of thought (CoT) to improve the gameplay of the video game; determining, based on a current state of the gameplay of the video game and based on the CoT, whether to cause at least a portion of the CoT to be rendered at the client device of the user; and in response to determining to cause at least the portion of the CoT to be rendered at the client device of the user, causing at least the portion of the CoT to be rendered at the client device of the user.

These and other implementations of technology disclosed herein can optionally include one or more of the following features.

In some implementations, determining to cause at least the portion of the CoT to be rendered at the client device of the user can be based on one or more of: determining that a predicted action to be performed by the user will deviate from the CoT; or determining that the user has paused in the gameplay for a threshold duration of time.

In some implementations, the method can further include, in response to determining to not cause at least the portion of the CoT to be rendered at the client device of the user continue processing the multimedia content, using the GM, to generate additional GM output; determine, based on the additional GM output, an additional CoT to further improve the gameplay of the video game; and determine, based on a subsequent current state of the gameplay of the video game and based on the additional CoT, whether to cause at least a portion of the additional CoT to be rendered at the client device of the user.

In some versions of those implementations, determining not to cause at least the portion of the CoT to be rendered at the client device of the user can be based on one or more of: determining that a predicted action to be performed by the user will not deviate from the CoT; or determining that the user has not paused in the gameplay for a threshold duration of time.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving multimedia content that captures gameplay of a video game, the multimedia content including at least one image frame of the gameplay of the video game;
receiving a natural language prompt that is associated with a client device of a user, the natural language prompt including a request with respect to the gameplay of the video game;
processing, using a generative model, GM input to generate GM output, the GM input including at least an indication of the natural language prompt and an indication of the multimedia content that captures the gameplay of the video game;
determining, based on the GM output, a chain of thought (CoT) to improve the gameplay of the video game; and
causing at least a portion of the CoT to be rendered at the client device of the user.

2. The method of claim 1, wherein the user is playing the video game, and wherein the natural language prompt is received while the user is playing the video game.

3. The method of claim 2, wherein the portion of the CoT is rendered without interrupting gameplay of the user.

4. The method of claim 2, wherein the portion of the CoT interrupts gameplay of the user.

5. The method of claim 2, wherein the request is to get from a current state of the video game to a final state of the video game, and wherein at least the portion of the CoT that is rendered does not include the final state of the video game.

6. The method of claim 5, further comprising:
receiving an additional natural language prompt that is associated with the client device of the user, the additional natural language prompt including an additional request for an additional portion of the CoT that is associated with the final state of the video game; and
in response to receiving the additional natural language prompt:
causing the additional portion of the CoT to be rendered at the client device of the user.

7. The method of claim 2, wherein the gameplay of the video game is at the client device of the user, and wherein the portion of the CoT is rendered at the client device of the user.

8. The method of claim 2, wherein the gameplay of the video game is at an additional client device, that is different than the client device of the user, and wherein the portion of the CoT is rendered at the client device of the user.

9. The method of claim 1, wherein the user has completed playing the video game, and wherein the natural language prompt is received subsequent to the user playing the video game.

10. The method of claim 9, wherein the request is to analyze the user's gameplay of the video game, and wherein the CoT includes suggested improvements to the gameplay of the video game.

11. The method of claim 1, wherein an additional user, that is in addition to the user, is playing the video game, and wherein the request is to analyze the additional user's gameplay of the video game to determine why the additional user performed a particular action in the gameplay of the video game.

12. The method of claim 11, wherein the CoT includes an indication of why the additional user performed the particular action in the gameplay of the video game and an indication of how the additional user could improve the gameplay of the video game.

13. The method of claim 1, further comprising:
prior to receiving the natural language prompt:
supervising fine-tuning of the generative model, wherein supervising fine-tuning the GM comprises:
obtaining a plurality of SFT training instances, each SFT training instance including a current state of the video game and a corresponding sequence of optimal actions to take in the current state of the video game and to arrive an optimal state in the video game;
processing, using the GM, the current state of the video game to generate a corresponding predicted CoT for guiding a human from the current state of the video game and towards the optimal state of the video game;
comparing the corresponding predicted CoT to a ground truth COT that is based on the corresponding sequence of optimal actions to generate one or more losses; and
updating, based on one or more of the losses, the GM.

14. The method of claim 13, wherein the current state of the video game includes at least one image frame of gameplay of the video game and/or includes state data for the current state of gameplay of the video game.

15. The method of claim 13, wherein processing the current state of the video game to generate the corresponding predicted CoT for guiding the human from the current state of the video game towards the optimal state of the video game comprises:
generating a plurality of possible actions for the human from the current state of the video game; and
for each possible action of the plurality of the possible actions:
processing, using the GM, the current state of the video game to generate the corresponding predicted CoT for guiding the human from the current state of the video game towards the optimal state of the video game; and
aggregating a plurality of the corresponding CoTs.

16. The method of claim 1, further comprising:
prior to receiving the natural language prompt:
performing reinforcement learning from human feedback (RLHF) of the generative model, wherein performing RLHF comprises:
obtaining a plurality of RLHF training instances, each RLHF training instance including at least a current state of the video game; processing, using the GM, the current state of the video game to generate a corresponding CoT for guiding a human from the current state of the video game to an optimal state of the video game;
causing the corresponding CoT to be rendered at a developer client device associated with a developer of the GM;
receiving, from the developer and via the developer client device, a feedback signal with respect to the corresponding CoT; and
updating, based on the feedback signal, the GM.

17. The method of claim 16, wherein updating the GM based on the feedback signal comprises:
processing, using a reward model, the feedback signal to determine a corresponding reward value; and
updating, based on the corresponding reward value, one or more parameters associated with the GM.

18. A system comprising:
a processor;
a memory coupled to the processor, the memory storing instructions that, when executed by the processor, cause the processor to be operable to:
receive multimedia content that captures gameplay of a video game, the multimedia content including at least one image frame of the gameplay of the video game;
receive a natural language prompt that is associated with a client device of a user, the natural language prompt including a request with respect to the gameplay of the video game;
process, using a generative model, GM input to generate GM output, the GM input including at least an indication of the natural language prompt and an indication of the multimedia content that captures the gameplay of the video game;
determine, based on the GM output, a chain of thought (CoT) to improve the gameplay of the video game; and
cause at least a portion of the CoT to be rendered at the client device of the user.

19. A non-transitory computer-readable storage medium storing instructions that, when executed by at least one processor, cause the at least one processor to execute the instructions to:
receive multimedia content that captures gameplay of a video game, the multimedia content including at least one image frame of the gameplay of the video game;
receive a natural language prompt that is associated with a client device of a user, the natural language prompt including a request with respect to the gameplay of the video game;
process, using a generative model, GM input to generate GM output, the GM input including at least an indication of the natural language prompt and an indication of the multimedia content that captures the gameplay of the video game;
determine, based on the GM output, a chain of thought (CoT) to improve the gameplay of the video game; and
cause at least a portion of the CoT to be rendered at the client device of the user.
